(19) United States
(12) Patent Application Publication
(10) Pub. No.: US 2010/0061877 A1
(43) Pub. Date: Mar. 11, 2010

(54) MAGNETIC MATERIALS, AND METHODS OF FORMATION

(76) Inventors: Mariam Sadaka, Austin, TX (US); Chris Young, Austin, TX (US); Vivek Mehrotra, Simi Valley, CA (US); Rahul Ganguli, Agoura Hills, CA (US)

Correspondence Address: DAVIS LAW GROUP, P.C., 6836 BEE CAVES ROAD, SUITE 220, AUSTIN, TX, 78746, US

(21) Appl. No.: 12/208,955

(22) Filed: Sep. 11, 2008

(51) Int. Cl. B22F 1/02; H01F 1/04; C01G 49/02

(52) U.S. Cl. 419/64; 252/62.51 R; 252/62.55; 252/62.56

(57) ABSTRACT

In a soft magnetic material, multiple flake-shaped magnetic particles: are coated by respective magnetic insulators; contain respective groups of magnetic nanoparticles; and are compacted to achieve magnetic exchange coupling between adjacent flake-shaped magnetic particles, and between adjacent magnetic nanoparticles within at least one of the flake-shaped magnetic particles.

### CROSS-REFERENCE TO RELATED APPLICATION

This application relates to co-owned co-pending U.S. patent application Ser. No. 11/769,437, filed Jun. 27, 2007, by Sadaka et al., entitled MAGNETIC MATERIALS MADE FROM MAGNETIC NANOPARTICLES AND ASSOCIATED METHODS, which is incorporated herein by reference in its entirety.

### TECHNICAL FIELD

The disclosures herein relate in general to magnetic materials, and in particular to methods of forming magnetic materials.

### BACKGROUND

Magnetic materials are useful in inductive components (e.g., inductors, transformers, and other components) of electronic devices. For example, with magnetic materials, inductive cores are formed in various shapes and configurations. For inductors or transformer cores, magnetic materials would ideally have high saturation magnetization (M_{S}), high permeability (μ), and low energy losses.

In some electronic devices, such as high frequency switched mode power supplies, suitable inductors are relatively large and have other limitations. For example, conventional inductors have relatively low permeability, and they exhibit an increase in eddy current losses at high frequencies. Also, conventional inductors are subject to high anisotropy and demagnetization effects at high frequencies.

Conventional soft magnetic materials (used in inductive cores) include ferrites, silicon steel, cobalt alloys, nickel iron, and other materials. These magnetic materials suffer from the problems mentioned above, when operated at high frequencies. Other materials, such as nanocrystalline soft magnetic materials (e.g., Finemet®), have similar problems. For example, Finemet® suffers from a drop in permeability at high frequencies. Also, core losses increase at high frequencies.

Thus, a need has arisen for soft magnetic materials that are suitable to form low-loss inductive devices for high frequency applications (e.g., switched mode power supplies, and other applications), and that maintain adequate magnetic properties (e.g., high permeability, high saturation magnetization, and other properties) at high frequencies. In addition to specified magnetic properties, a need has arisen for inductive devices that are smaller in size, in order to reduce cost and conserve printed circuit board space.

### SUMMARY

In a soft magnetic material, multiple flake-shaped magnetic particles: are coated by respective magnetic insulators; contain respective groups of magnetic nanoparticles; and are compacted to achieve magnetic exchange coupling between adjacent flake-shaped magnetic particles, and between adjacent magnetic nanoparticles within at least one of the flake-shaped magnetic particles.

### BRIEF DESCRIPTION OF THE DRAWING

FIG. 1 is a block diagram of a switched mode power supply with an inductor, according to the illustrative embodiments.

FIG. 2 is a diagram of adjacent magnetic nanoparticles.

FIG. 3 is a diagram of adjacent magnetic nanoparticles that are coated by coatings.

FIG. 4 is a diagram of a hysteresis loop, which shows a relationship between induced magnetic flux density and magnetizing force.

FIG. 5 is a cross-sectional diagram of a multi-layer magnetic nanoparticle, according to the illustrative embodiments.

FIG. 6 is a cross-sectional diagram of adjacent multi-layer magnetic nanoparticles, according to the illustrative embodiments.

FIG. 7 is a diagram of a mixture of two types of soft magnetic nanoparticles.

FIG. 8 is a diagram of a mixture of two types of soft magnetic nanoparticles, in which a first type of nanoparticle is coated, and a second type of nanoparticle is uncoated.

FIG. 9 is a cross-sectional diagram of a combustion driven compaction device.

FIG. 10 is a cross-sectional diagram of compacted nanoparticles without grain growth.

FIG. 11 is a cross-sectional diagram of partial grain growth in compacted nanoparticles.

FIG. 12 is a cross-sectional diagram of severe grain growth in compacted nanoparticles.

FIG. 13 is a diagram of particles with two size distributions.

FIG. 14 is a flowchart of one example method of forming a magnetic device with magnetic nanoparticles.

FIG. 15 is a diagram of amorphous tape.

FIG. 16 is a cross-sectional diagram of adjacent multi-layer magnetic nanoflakes, according to the illustrative embodiments.

FIG. 17 is a cross-sectional diagram of compacted nanoflakes without grain growth.

FIG. 18 is a cross-sectional diagram of partial grain growth in compacted nanoflakes.

FIG. 19 is a cross-sectional diagram of severe grain growth in compacted nanoflakes.

### DETAILED DESCRIPTION

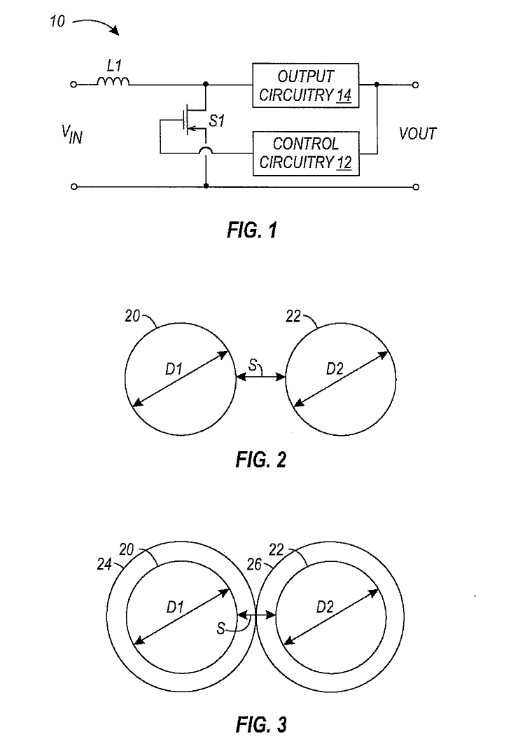

FIG. 1 is a block diagram of a switched mode power supply, indicated generally at 10, with an inductor L1, according to the illustrative embodiments. In some electronic devices, such as high frequency switched mode power supplies, suitable inductors are relatively large. Such inductors are specified to operate at high frequencies, while maintaining various magnetic properties. In such a high frequency switched mode power supply, one or more power transistors are rapidly and repeatedly switched on and off by a switching regulator, in order to generate a specified output voltage.

Accordingly, as shown in FIG. 1, the switched mode power supply 10 receives an input voltage V_{IN} and generates an output voltage V_{OUT}. The output voltage V_{OUT} is measured between a voltage output node and a voltage reference node (“ground”). In response to the then-current output voltage V_{OUT}, control circuitry 12 repeatedly turns a switch S1 (e.g., a metal oxide semiconductor field effect transistor, or “MOSFET”) on and off, in order to generate the specified output voltage V_{OUT}. When the switch S1 is closed, current flows through the inductor L1 to ground. When the switch S1 is open, energy stored in the inductor L1 flows as current through the output circuitry 14 to the voltage output node. The output circuitry 14 contains various circuitry, such as transformers, filters, and other circuitry. The power supply 10, which includes the inductor L1, benefits from magnetic materials of the illustrative embodiments.

The techniques of the illustrative embodiments are suitable to form improved magnetic materials. Such materials are advantageous in forming low loss inductive devices (e.g., the inductor L1) for switched mode power supplies (e.g., the power supply 10) and other applications. Inductive devices, formed according to the illustrative embodiments, are capable of maintaining adequate magnetic properties (e.g., relatively high saturation magnetization, relatively high permeability, relatively low energy losses, and other properties) at high frequencies (e.g., 10 MHz and higher).

When inductive devices, formed according to the illustrative embodiments, operate in high frequency circuits, such inductive devices achieve improved performance, and various other portions of the circuit are more easily simplified. For example, in the case of a power supply, a more efficient inductor is compatible for use with less expensive field-effect transistors (“FETs”), and with silicon devices in place of more expensive silicon carbide (“SiC”) devices. Moreover, by operating at high frequency, an electronic device is capable of achieving increased power density.

FIG. 2 is a diagram of adjacent magnetic nanoparticles (or “particles”). A first magnetic nanoparticle 20 is separated by a distance S from a second magnetic nanoparticle 22. The first nanoparticle 20 has a particle size, or diameter, of D1. The second nanoparticle 22 has a particle size, or diameter, of D2. Preferably, as further discussed below, the particle sizes D1 and D2 are less than the domain wall of the selected magnetic material, so that the nanoparticles 20 and 22 are single domain particles. With respect to exchange coupling, the magnetic nanoparticles 20 and 22 will be exchange coupled if the distance S is less than the exchange length (“Lex”) of the magnetic material selected.

In the illustrative embodiments, coated and compacted soft magnetic material is formed in a manner that increases permeability, reduces coercivity, reduces eddy currents, and achieves other benefits. Such material includes nanocomposite materials, which have magnetic nanoparticles (e.g., nanoparticles 20 and 22) embedded in a dielectric matrix. Such nanocomposite materials are preferable in electromagnetic devices that operate at high frequencies (e.g., inductors, DC-DC converters, and other devices).

In the illustrative embodiments, the magnetic nanoparticles are single domain particles, which help to reduce coercivity and increase permeability. The nanocomposite materials are selected, based on the exchange length of the particles, to achieve exchange coupling between particles. Two or more types of nanocomposite materials are selected, thereby achieving benefits of each type of material. For example, high magnetization material helps to achieve specified magnetic properties, while high exchange length material helps to achieve exchange coupling between particles.

FIG. 3 is a diagram of adjacent magnetic nanoparticles 20 and 22 that are coated by coatings 24 and 26, respectively. To increase exchange coupling between the nanoparticles 20 and 22, the coatings 24 and 26 are formed of magnetic materials (e.g., ferro or ferrimagnetic ferrites) instead of a conventional insulator. By comparison, with conventional coatings of previous techniques, the exchange process is more shielded, which reduces performance.

In the example of FIG. 3, the coatings 24 and 26 are touching (or “contacting”), which happens after the nanoparticles 20 and 22 are compacted. As shown in FIG. 3, the nanoparticles 20 and 22 are separated by the distance S, which is approximately equal to the total thickness of coatings 24 and 26. If the distance S is less than the exchange length of the magnetic nanoparticles 20 and 22, then nanoparticles 20 and 22 will be exchange coupled. Accordingly, such exchange coupling is controllable by selecting proper magnetic materials, particle sizes, and thickness of the coatings 24 and 26.

Also, in the illustrative embodiments, the particle coatings (e.g., coatings 24 and 26) have relatively low thicknesses, in comparison to the core diameters (e.g., diameters D1 and D2), which increases a percentage of core material in the matrix. The soft magnetic material is compacted with a rapid low temperature compaction technique, which helps to inhibit grain growth. Further, the compacted magnetic material is annealed to relieve mechanical stresses in the material, which helps to reduce losses.

A magnetic domain is a region in which the magnetic fields of atoms are grouped together and aligned. When a material becomes magnetized, all like magnetic poles become aligned and point in the same direction. If a particle is sufficiently small, the particle has only one domain, and is referenced as a single domain particle. In the illustrative embodiments, single domain particles are preferable to increase permeability and reduce coercivity.

Permeability is represented by the following equation:

$$μα \frac{{J}_{s}^{2} {A}^{3}}{{μ}_{0} {D}^{6} {K}_{1}^{4}} α {D}^{- 6} , \qquad ( 1 )$$

where μ is permeability, pᵤ is permeability, Jₛ is saturation magnetization, A is exchange stiffness, μ₀ is the permeability of free space, D is the grain size, and K₁ is the anisotropy constant. As shown in Equation (1), permeability is inversely proportional to the grain size D.

Coercivity is represented by the following equation:

$$H α \frac{{K}_{1}^{4} {D}^{6}}{{J}_{s} {A}^{3}} α {D}^{6} , \qquad ( 2 )$$

where H is coercivity, K₁ is the anisotropy constant, D is the grain size, Jₛ is saturation magnetization, and A is exchange stiffness. As shown in Equation (2), coercivity is proportional to the grain size D.

Thus, a smaller grain (or “particle”) size is preferable to increase permeability and reduce coercivity. A single domain grain is uniformly magnetized to its saturation magnetization. Generally, if the magnetic material's particle size distribution is less than its domain wall thickness, then it will be single domain, which increases permeability and reduces coercivity.

Accordingly, in the illustrative embodiments, the magnetic material is formed with carefully selected alloys that have: (a) relatively large domain wall thickness, which helps to achieve a single domain in such material's nanoparticles; and (b) relatively long exchange length (“Lex”), which helps to achieve magnetic exchange coupling between such material's nanoparticles. Between adjacent magnetic nanoparticles, such magnetic exchange coupling helps to reduce demagnetization and anisotropy of such nanoparticles. By selecting alloys that have relatively long exchange lengths, magnetic exchange coupling is more readily achieved (by exchange interaction) between adjacent grains that are separated by distances shorter than the exchange length. Ferromagnetic exchange coupling substantially enhances permeability, and substantially reduces anisotropy.

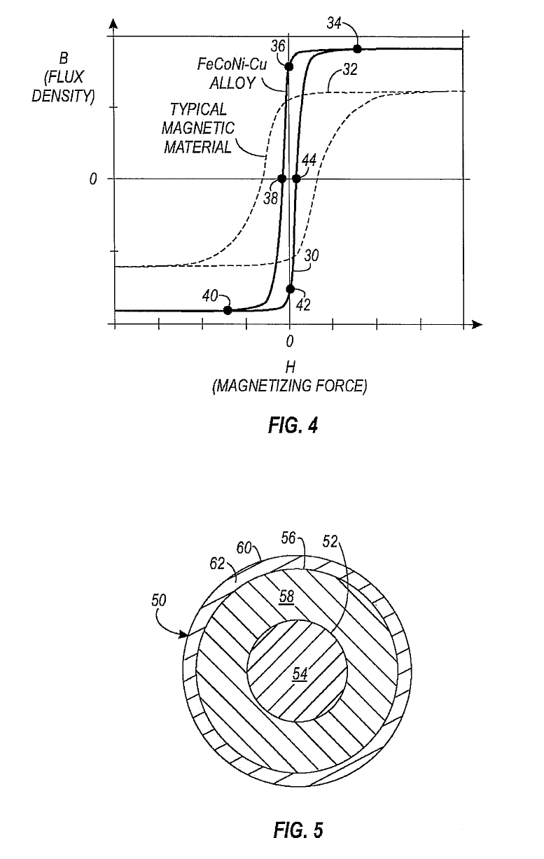

FIG. 4 is a diagram of a hysteresis loop (B-H loop), which shows a relationship between induced magnetic flux density (B) and magnetizing force (H). A B-H loop is generated by measuring a magnetic flux of a magnetic material while an applied magnetic force is changed. FIG. 4 shows a B-H loop 30 of FeCoNi—Cu alloy nanoparticles (solid lines) discussed below, and a B-H loop 32 of a conventional magnetic material (dashed lines).

In the illustrative embodiments, two or more types of soft magnetic material are selected for the magnetic nanoparticles. Preferably, the selected materials have a relatively high permeability (e.g., nanocrystalline alloys), a relatively long exchange length, and a relatively large domain wall. However, different types of magnetic materials have various advantages and disadvantages, so the selection process involves trade-offs.

For example, two types of available magnetic nanoparticles include FeCo at a 50:50 ratio (“iron cobalt”) and FeNi at a 25:75 ratio (“iron nitrate”). Iron cobalt has a relatively high saturation magnetization, but a relatively small domain wall, and a relatively short exchange length. By comparison, iron nitrate has a relatively large domain wall and a relatively large exchange length. Accordingly, a designer has discretion to select iron cobalt where a relatively high saturation magnetization is more important, or iron nitrate where exchange coupling is more important.

Accordingly, in the illustrative embodiments, two or more types of soft magnetic material are selected to achieve benefits of each type of material. In one embodiment, the magnetic nanoparticles are formed of a compound that includes three or more elements (e.g., so that each magnetic nanoparticle includes iron, cobalt, and nickel). Optionally, another element is added to enhance the compound's structural integrity, such as a relatively small amount of copper (e.g., 1%).

If magnetic material is formed of an FeCoNi—Cu alloy, it will have relatively high permeability and relatively low coercivity. The FeCoNi—Cu composition is selected to more fully achieve the benefits of each included element. The iron (Fe) provides relatively high saturation induction. The cobalt (Co) provides relatively high permeability. The nickel (Ni) provides a relatively low magnetic moment. The copper (Cu) controls the grain growth and reduces stress in the magnetic matrix.

In one example, the FeCoNi—Cu magnetic nanoparticles are provided in sizes of approximately 20 nm, which helps to achieve the benefits discussed above (e.g., single domain magnetic particles and exchange coupling). Moreover, a magnetic coating (further discussed below) is helpful to reduce eddy currents and increase exchange coupling.

As shown in FIG. 4, as a greater amount of magnetizing force (H+) is applied, the magnetic field in the magnetic material becomes stronger (B+). In the B-H loop 30 of the FeCoNi—Cu alloy, a first magnetic saturation occurs at a node 34, where almost all of the magnetic domains are aligned, so that additional increase in the magnetizing force will produce little additional increase in magnetic flux density. The B-H curve 30 moves from the node 34 to a node 36 if the magnetizing force is reduced to zero.

A first point of retentivity occurs at the node 36, where some magnetic flux density remains in the magnetic material, even though the magnetizing force is zero. This point of retentivity indicates residual magnetism in the magnetic material. As the magnetizing force is reversed in the negative direction, the B-H curve 30 moves from the node 36 to a node 38, where the magnetic flux density is zero.

A point of coercivity occurs at the node 38, where the reversed magnetizing force has flipped a sufficient number of the domains, so that the net magnetic flux density is zero within the magnetic material. As the negative magnetizing force is increased, a second magnetic saturation occurs at a node 40, where almost all of the magnetic domains are aligned, so that additional increase in the negative magnetizing force will produce little additional reduction in magnetic flux density. The B-H curve 30 moves from the node 40 to a node 42 if the magnetizing force is reduced to zero.

A second point of retentivity occurs at the node 42, where some negative magnetic flux density remains in the magnetic material, even though the magnetizing force is zero. This point of retentivity indicates residual magnetism in the magnetic material. Residual magnetism at the node 42 is equal to residual magnetism at the node 36. As the magnetizing force is reversed in the positive direction, the B-H curve 30 moves from the node 42 to the node 44, where the magnetic flux density is zero.

Various properties of a magnetic material are evidenced by its B-H loop. For example, after the magnetic saturation occurs, the magnetic material's retentivity (e.g., at nodes 36 and 42) indicates such material's ability to retain a certain amount of magnetic field after the magnetizing force is removed. After the point of retentivity occurs (e.g., at nodes 36 and 42), the magnetic material's coercive force is a measure of reverse magnetizing force that is applied for returning the magnetic flux density to zero (e.g., at nodes 38 and 44).

Accordingly, by comparing the B-H curve 30 with the B-H curve 32, the FeCoNi—Cu alloy's properties are readily compared to the conventional magnetic material's properties. For example, the B-H loop 32 is much wider than the B-H loop 30. Generally, if a material has a wider hysteresis loop, then such material has relatively low permeability (if total area is same), relatively high coercivity, relatively high losses, and relatively high residual magnetism, in comparison to a material that has a narrower hysteresis loop. Thus, with respect to various magnetic properties, FIG. 4 shows that the FeCoNi—Cu alloy is superior to the conventional magnetic material.

FIG. 5 is a cross-sectional diagram of a multi-layer magnetic nanoparticle, indicated generally at 50, according to the illustrative embodiments. The multi-layer magnetic nanoparticle 50 combines two or more types of magnetic material. In another example, the multi-layer magnetic nanoparticle combines three or more types (e.g., layers) of soft magnetic material.

The magnetic nanoparticle 50 has a core 52, which is formed of a core material 54. A shell 56 is formed of a shell material 58 that surrounds the core 52. The core material 54 and the shell material 58 are different types of magnetic material, having different magnetic properties. In one example: (a) the core material 54 has a relatively high saturation magnetization, a relatively small domain wall, and a relatively short exchange length; and (b) the shell material 58 has a relatively large exchange a length and a relatively large domain wall.

A coating 60 is formed of a coating material 62 that surrounds the shell 56. In one example, the coating material 62 includes magnetic materials (e.g., ferro or ferrimagnetic ferrites) to increase exchange coupling. Specific examples of coating materials are further discussed below.

Accordingly, in the illustrative embodiments, the beneficial magnetic properties of two or more types of material are achieved within a single magnetic device. In the example of FIG. 5, the selection of magnetic materials for magnetic nanoparticles includes the selection of multi-layered nanoparticles, so that a magnetic nanoparticle is formed of two or more types of material configured in a multi-layer arrangement. The multi-layer arrangement results in a magnetic device that achieves beneficial magnetic properties of both the core material and the shell material.

In one example, the core material 54 is iron cobalt (FeCo) at a 50:50 ratio. Iron cobalt has relatively high saturation magnetization and, accordingly, provides a relatively high magnetization core, which is preferable. Although iron cobalt has a relatively short exchange length (1.9 nm) and a relatively small domain wall (˜45 nm), such limitations do not cause a problem in the multi-layer magnetic nanoparticle 50. In this example, the core 52 is sufficiently small, so that the core 52 is a single domain particle. Also, despite the relatively short exchange length of iron cobalt, the core material 54 and the adjacent shell material 58 are exchange coupled, because the distance between the core material 54 and the adjacent shell material 58 is virtually zero.

In another example, the shell material 58 is iron nitrate (NiFe) at a 75:25 ratio. Iron nitrate has a relatively large domain wall (˜150 nm), which allows the shell 56 to continue being a single domain particle at larger sizes (in comparison to a different shell material that has a smaller domain wall). Also, iron nitrate has a relatively long exchange length, which helps to achieve exchange coupling between adjacent multi-layer magnetic nanoparticles.

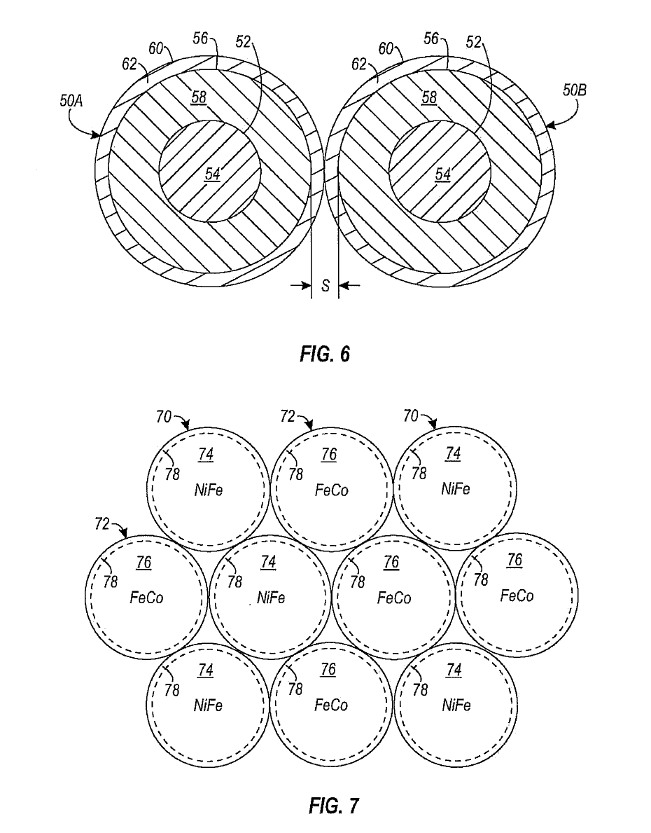

FIG. 6 is a cross-sectional diagram of adjacent multi-layer magnetic nanoparticles 50A and 50B, according to the illustrative embodiments. In this example, each of the nanoparticles 50A and 50B is substantially identical to the magnetic nanoparticle 50 of FIG. 5. As shown in FIG. 6, the nanoparticles 50A and 50B are touching, which happens after they are compacted.

The shell material of magnetic nanoparticle 50A is separated from the shell material of magnetic nanoparticle 50B by the distance S. If the distance S is less than the exchange length of the shell materials, then the shell materials of adjacent magnetic nanoparticles 50A and 50B will be exchange coupled. Accordingly, such exchange coupling is controllable by selecting proper shell materials, particle sizes, and thickness of the coatings.

If the shell materials are iron nitrate having a relatively long exchange length of 10.5 nm, then the adjacent nanoparticles 50A and 50B will be exchange coupled with one another, if combined thickness of their respective coatings is less than 10.5 nm. For example, if each nanoparticle's coating has a thickness of 5 nm, then: (a) combined thickness of their respective coatings is 10 nm (i.e., less than 10.5 nm); and (b) accordingly, the nanoparticles' respective shell materials are exchange coupled, because they are only 10 nm apart.

In that manner, the core material 54 and the shell material 58 are selectable to increase exchange coupling. In this example, an exchange length of the shell material 58 is longer than an exchange length of the core material 54. Conversely, if the shell material 58 were to have a relatively short exchange length, then exchange coupling between the adjacent nanoparticles 50A and 50B would be less likely. By comparison, a relatively short exchange length of the core material 54 is tolerable, because the core material 54 touches the shell material 58, which has a relatively long exchange length.

In another illustrative embodiment, magnetic nanoparticles are formed without a coating. In yet another illustrative embodiment, some nanoparticles are formed with a coating, while other nanoparticles are formed without a coating. In still another illustrative embodiment, a coating layer is interposed between a nanoparticle's core material and the nanoparticle's shell material. In at least one illustrative embodiment, the nanoparticles are deformable when compacted (discussed below), so that the nanoparticles' shapes are variable from the cross-sectional diagrams shown in FIGS. 5 and 6.

FIG. 7 is a diagram of a mixture of different types of soft magnetic nanoparticles, which are selected according to techniques of the illustrative embodiments. A first type of magnetic nanoparticle 70 is formed of a first magnetic material 74, such as iron nitrate. A second type of magnetic nanoparticle 72 is formed of a second magnetic material 76, such as iron cobalt. In the example of FIG. 7, each nanoparticle includes an optional coating 78 to reduce eddy current losses. The coating 78 is preferably formed of a magnetic material, as discussed below.

In the example of FIG. 7, a soft magnetic material is formed of a mixture of two or more types of magnetic nanoparticles, in a manner that randomly distributes the nanoparticles throughout the soft magnetic material. Accordingly, in this example, the nanoparticles have various characteristics that contribute specified magnetic properties. By mixing different types of nanoparticles, according to techniques of the illustrative embodiments, the soft magnetic material achieves beneficial magnetic properties of such types.

In one example, the mixture includes nanoparticles that have a relatively high magnetization to achieve specified magnetic properties. In this example, the mixture also includes nanoparticles that have a relatively high exchange length to increase exchange coupling between particles. Further, in this example, both types of nanoparticles are selected and sized to be single domain particles.

As shown in FIG. 7, based on the specified magnetic properties of this example, suitable materials for the magnetic nanoparticles include iron cobalt (FeCo) at a 50:50 ratio and iron nitrate (NiFe) at a 75:25 ratio. Iron cobalt has relatively high saturation magnetization and, accordingly, provides a relatively high magnetization core, which is preferable. Also, iron cobalt has a relatively short exchange length (1.9 nm) and a relatively small domain wall (˜45 nm).

Iron nitrate has a relatively large domain wall (˜150 nm), which allows such nanoparticles to continue being single domain particles at larger sizes (in comparison to a different material that has a smaller domain wall). Also, iron nitrate has a relatively long exchange length, which helps to achieve exchange coupling between adjacent nanoparticles. In this example, the mixture of iron cobalt and iron nitrate achieves a magnetic device that has superior magnetic properties over conventional magnetic devices.

FIG. 8 is a diagram of a mixture of two types of soft magnetic nanoparticles, in which a first type of nanoparticle is coated, and a second type of nanoparticle is uncoated. As shown in FIG. 8: (a) the nanoparticles 70, which are formed of iron nitrate, are coated; and (b) the nanoparticles 72, which are formed of iron cobalt, are uncoated. This technique increases exchange coupling between the nanoparticles 72 (which have a relatively short exchange length) and their adjacent nanoparticles, because separation between such nanoparticles is shortened.

A potential shortcoming of this arrangement is that adjacent nanoparticles 72 (which are formed of iron cobalt) are less likely to be insulated from one another. In view of that fact, the magnetic material has an increased likelihood of weak spots. Nevertheless, in the illustrative embodiments, this shortcoming is overcome by distributing the nanoparticles 72 in a substantially uniform manner within the magnetic material, and/or by increasing a concentration of the nanoparticles 70 (which are formed of iron nitrate) to reduce a number of weak spots in the magnetic material.

In some of the examples discussed above, a nanoparticle includes a coating, which surrounds the nanoparticle's entire core. A primary purpose of the coating is to reduce eddy current losses in the magnetic material. In the illustrative embodiments, a preferable coating is selected for the nanoparticles, according to the coating's purpose, and according to the coating's beneficial effects on magnetic properties of the magnetic material. Eddy current losses are proportional to frequency, and inversely proportional to resistivity, as shown in the following equation:

Eddy current losses

$$∝ \frac{{Af}^{2}}{ρ} , \qquad ( 3 )$$

where A is a constant, f is frequency, and ρ is resistivity.

Preferably, a coating is resistive, because one goal is to reduce eddy current losses. Moreover, a resistive coating increases the skin depth (δ), as shown in the following equation:

$$δ = \sqrt{\frac{ρ}{π f μ}} , \qquad ( 4 )$$

where ρ is resistivity, f is frequency, and μ is permeability.

When magnetic particles are sufficiently close together, conduction is more likely between the particles. The nanoparticle's resistive coating increases the skin depth, and thereby assists with this conduction. Preferably: (a) the coating's material is inert, so that it will substantially avoid reaction with the nanoparticles after the compaction process; and (b) the coating will remain stable during and after the compaction process.

In the illustrative embodiments, the coatings are formed of magnetic insulators (e.g., ferro or ferrimagnetic ferrites) instead of a conventional insulator, so that exchange coupling is increased. By comparison, if the coatings are formed of nonmagnetic insulators, the coatings are more likely to degrade the magnetic device's performance by reducing exchange coupling. Similarly, an anti-ferromagnetic coating (e.g., alpha Fe₂O₃) is more likely to degrade the magnetic device's performance.

Numerous coatings are suitable for use in the illustrative embodiments. Examples of suitable coatings include, but are not limited to, gamma Fe₂O₃, a NiFe ferrite, a FeCo ferrite, and other ferrites. Various processes are suitable for coating nanoparticles. In one example, coatings are applied in-situ to reduce handling of the nanoparticles. Moreover, by coating the nanoparticles in-situ, the nanoparticles have a lower risk of exposure to the atmosphere. Such exposure would increase a likelihood of undesirable oxidation of the nanoparticles.

In the process of coating nanoparticles, the coating's thickness is preferably less than one-half of the nanoparticle's exchange length, in order to maintain exchange coupling. Preferably, the coating's thickness is sufficiently low, so that total volume of the coating is relatively small in comparison to volume of the nanoparticle's core (which thereby increases a percentage of core material in the magnetic matrix). If the coating's thickness increases, then a higher percentage of coating material exists in the magnetic matrix, which thereby reduces magnetic properties of the magnetic material. Accordingly, in forming magnetic materials from nanoparticles, a relatively small coating thickness is preferable, and a relatively large core diameter is preferable.

Various techniques (e.g., gas phase plasma process) are suitable to form the magnetic nanoparticles of the illustrative embodiments. Preferably, the magnetic nanoparticles are formed without exposure to the atmosphere, because such exposure would increase a likelihood of undesirable oxidation of the nanoparticles. If the nanoparticles are coated in-situ, then the nanoparticles are substantially protected from the atmosphere before they leave the reactor.

After the magnetic nanoparticles are formed, they are incorporated into a specified magnetic device. For an inductor, the nanoparticles are incorporated into a toroid, or other shape as specified. For a transformer, the nanoparticles are incorporated into a loop, or other shape as specified. In a compaction process, the magnetic particles are compressed and compacted to form the specified magnetic device. In one example, rapid low-pressure compaction is used for increasing packing density and for helping to prevent grain growth.

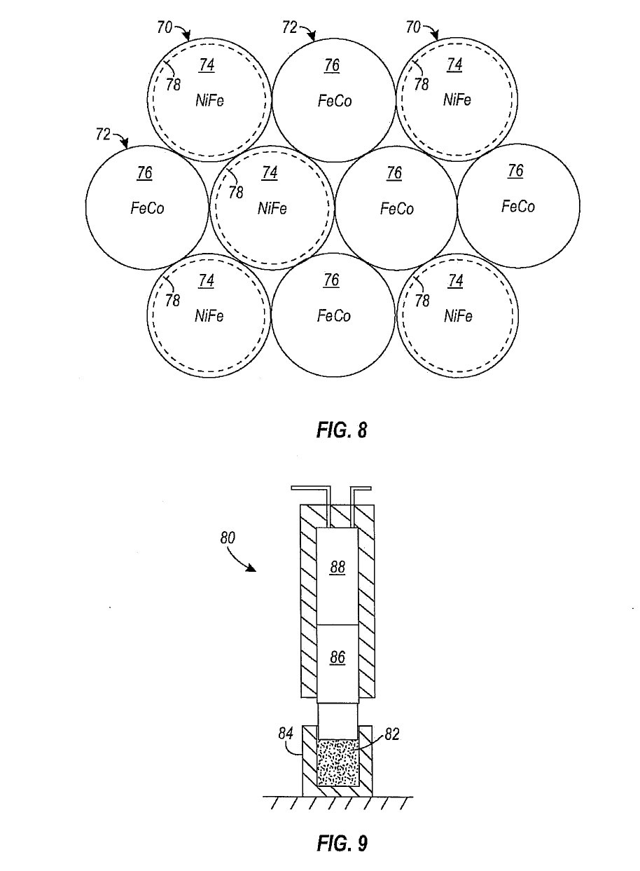

FIG. 9 is a cross-sectional diagram of a combustion driven compaction device, indicated generally at 80. One such device is available from Utron Inc. of Manassas, Va. The Utron compaction device is further discussed in U.S. Pat. No. 6,767,505, which is incorporated by reference herein. As shown in FIG. 9, the compaction device 80 compacts magnetic nanoparticles 82 within a die 84. A high-pressure piston 86 compacts the nanoparticles 82 when gas within a gas chamber 88 is ignited. The nanoparticles 82 are compressed and compacted into a densely formed part. This process is relatively fast, and occurs at room temperature, which reduces strain that can otherwise result from the compaction processes.

When forming magnetic devices, increased compaction of the nanoparticles is preferable. On a first hand, if the compaction is incomplete, then even a small amount of porosity from the incomplete compaction will increase a likelihood of significant deep magnetization. On a second hand, grain growth increases a likelihood of reduced magnetic induction, and of significantly increased loss.

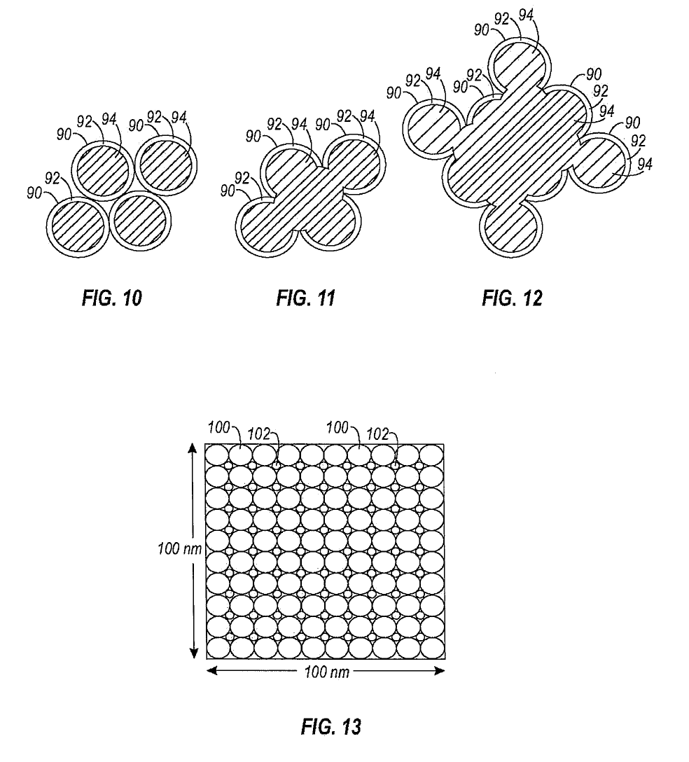

FIG. 10 is a cross-sectional diagram of the compacted nanoparticles 90 without grain growth. Each of the nanoparticles 90 has a respective coating 92 and a respective magnetic core 94, as discussed above. In FIG. 10, the nanoparticles 90 are compacted, and no grain growth is present. As shown in FIG. 10, the coatings 92 of the nanoparticles 90 are intact.

FIG. 11 is a cross-sectional diagram of partial grain growth in the compacted nanoparticles 90. As shown in FIG. 11, some of the coatings 92 of the nanoparticles 90 have broken during the compaction process, which results in grain growth. When grain growth occurs, the core material from adjacent particles is compacted together.

FIG. 12 is a cross-sectional diagram of severe grain growth in the compacted nanoparticles 90. As shown in FIG. 12, several of the coatings 92 of the nanoparticles 90 have broken during the compaction process. Also, a relatively large amount of the core material from adjacent particles is compacted together.

Severe grain growth results in electrical percolation, which increases a likelihood that magnetic material thicknesses will undesirably exceed the skin depth. At high frequencies, such larger thicknesses reduce the magnetic induction, thereby severely increasing loss. In the illustrative embodiments, such loss is substantially avoided by properly compacting the nanoparticles, so that a suitable amount of pressure is applied at the appropriate temperature to reduce grain growth during the compaction process.

If specified, the compacted magnetic nanoparticles are annealed to relieve mechanical stress. Conventionally, annealing is performed by applying heat or ultrasonic energy to the compacted particles in an inert gas, such as hydrogen, nitrogen, argon, and other gasses. In addition to relieving mechanical stress, annealing helps to reduce losses in the magnetic material.

FIG. 13 is a diagram of particles with two size distributions, which helps to achieve higher green density. For example, the mixture of two or more types of magnetic nanoparticles will often have different domain lengths, which results in at least two particle size distributions. If adjacent contacting particles have different size distributions, then a higher green density (weight per unit volume of an unsintered compaction) is achievable.

As shown in FIG. 13, within an area of 100 nm by 100 nm, a first type of magnetic nanoparticle 100 is distributed. The nanoparticles 100 are single domain particles having a domain length of approximately 10 nm. A second type of magnetic nanoparticle 102 is distributed between the nanoparticles 100. As shown in FIG. 13, the nanoparticles 102 are smaller than the nanoparticles 100. The resulting magnetic material (with the nanoparticles 100 and 102) has a higher green density than it would otherwise have with the nanoparticles 100 alone.

Even if the magnetic material has only a single type of magnetic nanoparticle alloy, the nanoparticles will still have a size distribution, due to inherent properties of the processes that form the nanoparticles. In this example, various techniques (e.g., sieving) are useful for truncating the size distribution (e.g., by removing particles larger than the domain wall thickness). Such techniques help to achieve single domain particles, while continuing to achieve a higher green density (as a result of the particles' varying sizes).

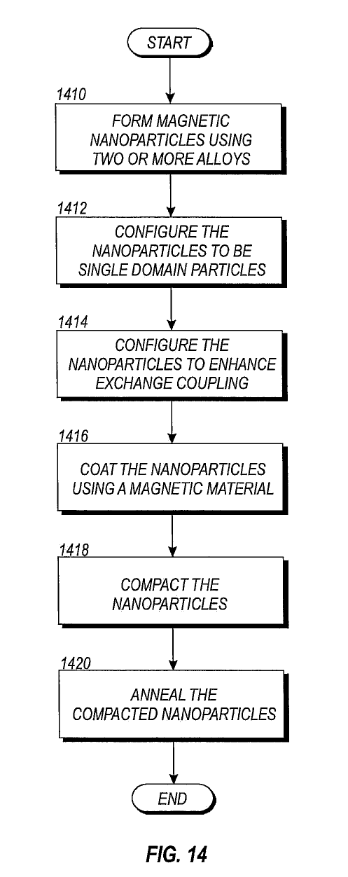

FIG. 14 is a flowchart of one example method of forming a magnetic device with magnetic nanoparticles. The method begins at a step 1410, where magnetic nanoparticles are formed of two or more types of alloys, which have different magnetic properties (FIG. 4). For example, a tertiary alloy is useful for achieving benefits from different magnetic properties of three types of alloys. In another example, multi-layer magnetic nanoparticles are useful for achieving benefits from different magnetic properties of the layers' respective materials (FIGS. 5-6). In another example, a mixture of different types of soft magnetic nanoparticles is useful for achieving benefits from different magnetic properties of such types (FIGS. 7-8).

At a next step 1412, the nanoparticles are configured to be single domain particles, which help to advantageously reduce coercivity and increase permeability. The nanoparticles are configurable as single domain particles by forming the particles at a size that is less than the domain wall of the particles' material.

At a next step 1414, the nanoparticles are configured to increase exchange coupling. If the particles are exchange coupled, they achieve lower anisotropy and better magnetic properties than particles that are not exchange coupled. The nanoparticles are configurable to increase exchange coupling by controlling the type of material, controlling the thickness of particle coatings, controlling the distances between materials, and other parameters.

At a next step 1416, the nanoparticles are coated with a magnetic material. As discussed above, if the coating material is formed of a magnetic material (e.g., ferro or ferrimagnetic ferrites), exchange coupling is increased.

At a next step 1418, the nanoparticles are compacted, according to a compaction technique. In one example, a rapid low-temperature compaction technique is used, such as combustion driven compaction.

At a next step 1420, if specified, the compacted nanoparticles are annealed to relieve mechanical stress and reduce losses.

FIG. 15 is a diagram of amorphous tape. The amorphous tape is conventional (e.g., commercially available from Finemet® or Vacoflux®), and it contains nanoparticles. Preferably, the amorphous tape: (a) is formed by crystallization, which helps to define grain structure (e.g., by suppressing grain growth); (b) has a small grain size (e.g., less than 20 nm); and (c) has magnetic material with low crystalline anisotropy.

In an illustrative embodiment, a mechanical milling (e.g., ball milling, cryo-milling, or other standard milling technique) is performed on the amorphous tape, in a manner that generates soft magnetic nanoflakes (e.g., having thicknesses between 1 micron and 2 microns) from a disintegration of the amorphous tape as a result of such milling. In this example, each nanoflake: (a) is a particle that is flake-shaped (e.g., oval-shaped); and (b) itself contains (or is formed of) a group of even smaller magnetic nanoparticles. Longer milling time will: (a) reduce the average size of the nanoflakes; and (b) narrow the overall size distribution of the nanoflakes.

Preferably, the milling is performed by grinding, and without exposing the amorphous tape to the atmosphere (e.g., milling performed in a vacuum), because such exposure would increase a likelihood of undesirable oxidation of the nanoflakes. Alternatively, the milling is performed by another process (e.g., low-cost microforging). For example, if the milling is performed by microforging, the nanoflakes are micron-sized particles.

FIG. 16 is a cross-sectional diagram of adjacent multi-layer magnetic nanoflakes, according to the illustrative embodiments. As shown in FIG. 16, the nanoflakes are coated with magnetic insulators (e.g., ferro or ferrimagnetic ferrites), in the same manner as other particles are coated in the example of FIG. 3 above. Accordingly, in view of the fact that the nanoflake is likewise a type of particle of the illustrative embodiments, the nanoflake is: (a) coated according to the step 1416 of FIG. 14; (b) compacted according to the step 1418 of FIG. 14; and (c) optionally, annealed according to the step 1420 of FIG. 14.

In the illustrative embodiments, the nanoflake coatings have relatively low thicknesses, in comparison to thicknesses of the nanoflakes, which increases a percentage of core material in the matrix. After the nanoflakes are coated, they can be exposed to the atmosphere, because the coating protects against oxidation. Within a nanoflake (which itself contains even smaller nanoparticles), all such nanoparticles preferably have a single domain, aligned with one another.

After such coating and compaction, a final width (i.e., the shorter dimension of width vs. length) of each compacted nanoflake is preferably less that the skin depth, so that current flow is substantially distributed across the entirety of any given cross-section of the compacted nanoflake material. If a significant number of nanoflakes are wider than the skin depth, then eddy currents will undesirably reduce the magnetic induction in the compacted nanoflake material at high frequencies. In one example: (a) Finemet® material had a skin depth of ˜50 microns at 10 MHz frequency of operation; and (b) Finemet® amorphous tape was milled for ˜10 minutes, which was sufficient to achieve less than ˜50 micron width per compacted nanoflake.

By coating, compacting, and optionally annealing the various nanoflakes, in the same manner as further discussed above, the nanoflakes achieve the various benefits (e.g., increased permeability, reduced coercivity, reduced eddy currents, and other benefits) that are further discussed above in connection with such coating, compacting, and optional annealing. Accordingly, such nanoflakes achieve the various benefits of nanoparticles that are further discussed above, but such nanoflakes have an advantage of being larger and more easily handled than such nanoparticles.

In the illustrative embodiment, the nanoflakes have relatively long exchange length (“Lex”), which helps to achieve magnetic exchange coupling: (a) between adjacent nanoflakes (“inter-exchange coupling”) that are separated by a distance shorter than Lex, as shown by the large bi-directional arrow in FIG. 16; and (b) between adjacent nanoparticles (“intra-exchange coupling”) within each nanoflake, as shown by the small bidirectional arrows in FIG. 16. Accordingly, the compacted nanoflake material achieves two levels of exchange coupling, namely inter-exchange coupling and intra-exchange coupling.

Such magnetic exchange coupling helps to reduce demagnetization and anisotropy of such nanoflakes. By selecting alloys that have relatively long exchange lengths, magnetic exchange coupling is more readily achieved (by exchange interaction) between adjacent grains that are separated by distances shorter than the exchange length. Ferromagnetic exchange coupling substantially enhances permeability, and substantially reduces anisotropy. Accordingly, in the illustrative embodiments, such enhanced magnetic properties are maintained in inductive devices (e.g., the inductor L1 of FIG. 1) that are formed by the particles (e.g., nanoflakes) of the illustrative embodiments, even at high frequencies of the circuitry (e.g., the power supply 10 of FIG. 1) in which such inductive devices operate.

The nanoflakes have irregular shapes and sizes, which can help to achieve higher green density. Also, the nanoflakes have relatively high aspect ratios (lateral dimension/thickness ratio). The nanoflake's relatively small thickness and relatively large shape anisotropy (relatively high aspect ratio) help to reduce demagnetization and increase permeability, so that the compacted nanoflake material retains its magnetization better, as shown in the following equations:

$$\begin{matrix}{μ}^{′} = \frac{1}{\frac{1}{μ} - \frac{N}{4 π}} , & ( 5 ) \\ m = \frac{Length}{Diameter} , & ( 6 ) \\ N α \frac{1}{m} , & ( 7 )\end{matrix}$$

where μ′ is apparent permeability, μ is true permeability, m is aspect ratio, and N is demagnetizing factor.

As shown by Equations (5), (6) and (7), as N decreases: (a) μ′ approaches μ (so that high μ indicates high μ′, and low μ indicates low μ′); and (b) the compacted nanoflake material retains its magnetization better, so that such material is harder to demagnetize. A higher aspect ratio m results in a lower demagnetizing factor N, which in turn results in a higher permeability. Accordingly, in the illustrative embodiments, the milled nanoflakes have a relatively high aspect ratio (in comparison to various other nanoparticles), which is advantageous.

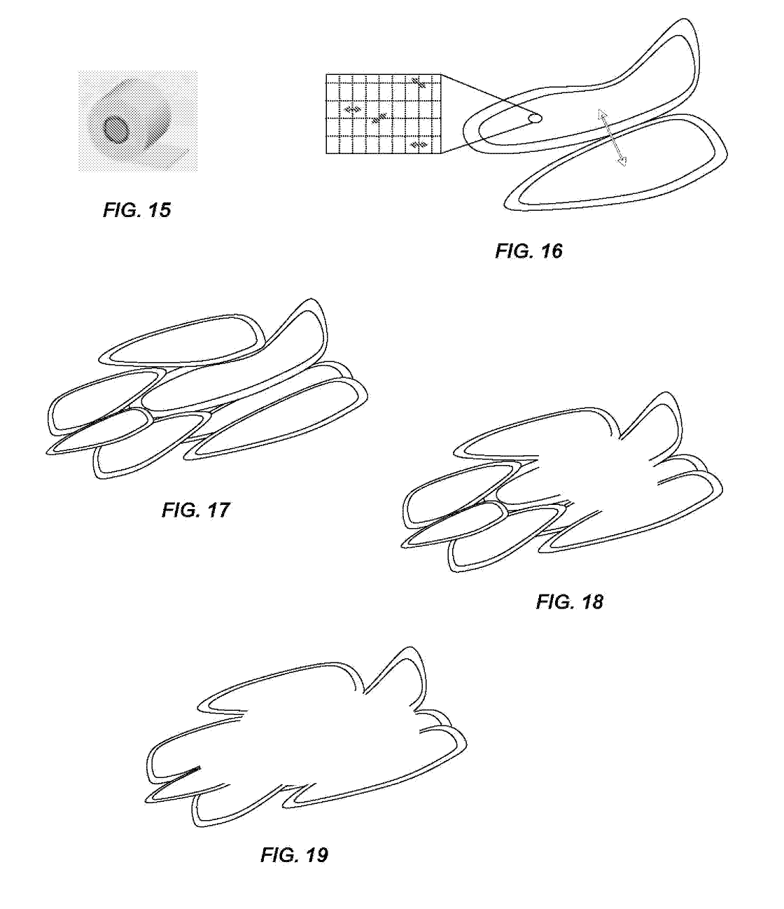

FIG. 17 is a cross-sectional diagram of the compacted nanoflakes without grain growth. Each of the nanoflakes has a respective coating, as discussed above. In FIG. 17, the nanoflakes are compacted, and no grain growth is present. As shown in FIG. 17, the coatings of the nanoflakes are intact.

FIG. 18 is a cross-sectional diagram of partial grain growth in the compacted nanoflakes. As shown in FIG. 18, some of the coatings of the nanoflakes have broken during the compaction process, which results in grain growth. When grain growth occurs, the core material from adjacent nanoflakes is compacted together.

FIG. 19 is a cross-sectional diagram of severe grain growth in the compacted nanoflakes. As shown in FIG. 19, several of the coatings of the nanoflakes have broken during the compaction process. Also, a relatively large amount of the core material from adjacent nanoflakes is compacted together.

Severe grain growth results in electrical percolation, which increases a likelihood that magnetic material thicknesses will undesirably exceed the skin depth. At high frequencies, such larger thicknesses reduce the magnetic induction, thereby severely increasing loss. In the illustrative embodiments, such loss is substantially avoided by properly compacting the nanoflakes, so that a suitable amount of pressure is applied at the appropriate temperature to reduce grain growth during the compaction process.

If specified, the compacted magnetic nanoflakes are annealed to relieve mechanical stress. Conventionally, annealing is performed by applying heat or ultrasonic energy to the compacted nanoflakes in an inert gas, such as hydrogen, nitrogen, argon, and other gasses. In addition to relieving mechanical stress, annealing helps to reduce losses in the magnetic material.

Although illustrative embodiments have been shown and described, a wide range of modification, change and substitution is contemplated in the foregoing disclosure. In some instances, various features of the embodiments may be used without a corresponding use of other features. For example, although techniques of the illustrative embodiments are useful in the environments discussed above, such techniques are useful in other types of environments where magnetic materials are applied.

What is claimed is:

1. A soft magnetic material comprising:
a plurality of flake-shaped magnetic particles that: are coated by respective magnetic insulators; contain respective groups of magnetic nanoparticles; and are compacted to achieve magnetic exchange coupling between adjacent flake-shaped magnetic particles, and between adjacent magnetic nanoparticles within at least one of the flake-shaped magnetic particles.

2. The soft magnetic material of claim 1, wherein the magnetic nanoparticles include single domain nanoparticles.

3. The soft magnetic material of claim 2, wherein the soft magnetic material is formed with at least one alloy that is selected to achieve the single domain nanoparticles.

4. The soft magnetic material of claim 3, wherein the alloy is selected to increase a domain wall thickness of the soft magnetic material.

5. The soft magnetic material of claim 1, wherein the magnetic insulators include a Ferrite.

6. The soft magnetic material of claim 1, wherein the magnetic insulators include at least one of the following: Gamma Fe₂O₃; and other Ferrites.

7. The soft magnetic material of claim 1, wherein a thickness of the magnetic insulators is sized to achieve the magnetic exchange coupling between adjacent flake-shaped magnetic particles.

8. The method of claim 1, wherein the compacting comprises:
compacting the flake-shaped magnetic particles by a fast compaction process at high pressure and low temperature.

9. The soft magnetic material of claim 1, wherein the flake-shaped magnetic particles are compacted by a combustion driven compaction process.

10. The soft magnetic material of claim 1, wherein the compacted flake-shaped magnetic particles are annealed to relieve stresses therein.

11. The soft magnetic material of claim 1, wherein the soft magnetic material is formed with at least one alloy that is selected to achieve the magnetic exchange coupling between adjacent flake-shaped magnetic particles, and between adjacent magnetic nanoparticles within at least one of the flake-shaped magnetic particles.

12. The soft magnetic material of claim 11, wherein the alloy is selected to increase an exchange length of the soft magnetic material.

13. The soft magnetic material of claim 1, wherein the flake-shaped magnetic particles are formed by milling an amorphous tape that contains the magnetic nanoparticles.

14. The soft magnetic material of claim 13, wherein the flake-shaped magnetic particles are formed by milling the amorphous tape, without exposing the amorphous tape to an atmosphere.

15. The soft magnetic material of claim 13, wherein the flake-shaped magnetic particles are formed by grinding the amorphous tape.

16. The soft magnetic material of claim 13, wherein the flake-shaped magnetic particles are formed by microforging the amorphous tape.

17. The soft magnetic material of claim 1, wherein the flake-shaped magnetic particles are formed to have high aspect (lateral dimension/thickness) ratios.

18. A method of making soft magnetic material, the method comprising:
forming a plurality of flake-shaped magnetic particles that contain respective groups of magnetic nanoparticles;
coating the flake-shaped magnetic particles with respective magnetic insulators; and
compacting the flake-shaped magnetic particles to achieve magnetic exchange coupling between adjacent flake-shaped magnetic particles, and between adjacent magnetic nanoparticles within at least one of the flake-shaped magnetic particles.

19. The method of claim 18, wherein the forming comprises:
forming the flake-shaped magnetic particles that contain respective groups of magnetic nanoparticles including single domain nanoparticles.

20. The method of claim 19, wherein the forming comprises:
forming the flake-shaped magnetic particles with at least one alloy that is selected to achieve the single domain nanoparticles.

21. The method of claim 20, wherein the forming comprises:
forming the flake-shaped magnetic particles with at least one alloy that is selected to increase a domain wall thickness of the soft magnetic material.

22. The method of claim 18, wherein the coating comprises:
coating the flake-shaped magnetic particles with respective magnetic insulators that include a Ferrite.

23. The method of claim 18, wherein the coating comprises:
coating the flake-shaped magnetic particles with respective magnetic insulators that include at least one of the following: Gamma Fe₂O₃; and other Ferrites.

24. The method of claim 18, wherein the coating comprises:
coating the flake-shaped magnetic particles with respective magnetic insulators whose thickness is sized to achieve the magnetic exchange coupling between adjacent flake-shaped magnetic particles.

25. The method of claim 18, wherein the compacting comprises:
compacting the flake-shaped magnetic particles by a fast compaction process at high pressure and low temperature.

26. The method of claim 18, wherein the compacting comprises:
compacting the flake-shaped magnetic particles by a combustion driven compaction process.

27. The method of claim 18, and comprising:
annealing the compacted flake-shaped magnetic particles to relieve stresses therein.

28. The method of claim 18, wherein the forming comprises:
forming the flake-shaped magnetic particles with at least one alloy that is selected to achieve the magnetic exchange coupling between adjacent flake-shaped magnetic particles, and between adjacent magnetic nanoparticles within at least one of the flake-shaped magnetic particles.

29. The method of claim 28, wherein the forming comprises:
forming the flake-shaped magnetic particles with at least one alloy that is selected to increase an exchange length of the soft magnetic material.

30. The method of claim 18, wherein the forming comprises:
forming the flake-shaped magnetic particles by milling an amorphous tape that contains the magnetic nanoparticles.

31. The method of claim 30, wherein the milling comprises:
forming the flake-shaped magnetic particles by milling the amorphous tape, without exposing the amorphous tape to an atmosphere.

32. The method of claim 30, wherein the milling comprises:
forming the flake-shaped magnetic particles by grinding the amorphous tape.

33. The method of claim 30, wherein the milling comprises: forming the flake-shaped magnetic particles by microforging the amorphous tape.

34. The soft magnetic material of claim 18, wherein the flake-shaped magnetic particles are formed to have high aspect (lateral dimension/thickness) ratios.
